(19) United States
(12) Patent Application Publication
(10) Pub. No.: US 2025/0029755 A1
(43) Pub. Date: Jan. 23, 2025

(54) OVER-CURRENT PROTECTION DEVICE

(71) Applicant: Polytronics Technology Corp., Hsinchu (TW)

(72) Inventors: Chingting CHIU, Taoyuan City (TW); Hsiu-Che YEN, Taoyuan City (TW); Chia-Yuan LEE, Hsinchu City (TW); Chen-Nan LIU, Pitou Township, Changhua County (TW); Cheng-Yu TUNG, Tainan City (TW); Yung-Hsien CHANG, Douliu City (TW); Yao-Te CHANG, Linnei Township, Yunlin County (TW); Fu-Hua CHU, Taipei City (TW)

(21) Appl. No.: 18/422,822

(22) Filed: Jan. 25, 2024

(30) Foreign Application Priority Data
Jul. 12, 2023 (TW) 112125971

(51) Int. Cl. H01C 7/02; H01C 1/14; H02H 9/02

(52) U.S. Cl. CPC H01C 7/027; H01C 1/1406; H02H 9/026

(57) ABSTRACT

An over-current protection device includes an electrode layer and a heat-sensitive layer. The heat-sensitive layer exhibits a positive temperature coefficient (PTC) characteristic, and is laminated between a top metal layer and a bottom metal layer of the electrode layer. The heat-sensitive layer includes a polymer matrix and a conductive filler. The polymer matrix includes a first fluoropolymer and a second fluoropolymer. The first fluoropolymer has a first volume and a first melt flow index, and the second fluoropolymer has a second volume and a second melt flow index. The second melt flow index ranges from 0.4 g/10 min to 0.7 g/10 min and is lower than the first melt flow index, and a volume ratio by dividing the second volume by the first volume ranges from 0.4 to 0.6.

### BACKGROUND OF THE INVENTION

### (1) Field of the Invention

The present application relates to an over-current protection device, and more specifically, to a low-resistivity over-current protection device for high-power applications.

### (2) Description of the Related Art

Because the electrical resistance of conductive composite materials having a positive temperature coefficient (PTC) characteristic is very sensitive to temperature variation, they can be used as the materials for current sensing devices and have been widely applied to over-current protection devices or circuit devices. More specifically, the electrical resistance of the PTC conductive composite material remains extremely low at normal temperatures, so that the circuit or battery cell can operate normally. However, when an over-current or an over-temperature situation occurs in the circuit or cell, the electrical resistance will instantaneously increase to a high electrical resistance state (e.g., at least above 10⁴ Ω, which is the so-called “trip”. Therefore, the over-current will be eliminated so as to protect the cell or the circuit device.

The basic structure of an over-current protection device consists of a PTC material layer with two electrodes bonded to two opposite sides of the PTC material layer. The PTC material layer includes a matrix and a conductive filler. The matrix consists of at least one polymer, and the conductive filler is uniformly dispersed in the matrix and is used as an electrically conductive path. In order to meet the requirement of overheating protection at higher temperature, a fluoropolymer (e.g., polyvinylidene difluoride) is generally selected as the major constituent in the matrix. In addition, the conductive filler can be roughly divided into two types according to its composition: the first type of conductive filler consists of carbon black and at least one metal compound, while the second type of conductive filler consists of carbon black. The first type of conductive filler may be referred to as “conductive filler for low electrical resistivity,” and the over-current protection device that includes this type of conductive filler may be referred to as “over-current protection device with low electrical resistivity,” or simply the LR over-current protection device. Conventionally, although the LR over-current protection device with a PVDF-based matrix (referred to as “PVDF LR over-current protection device” hereinafter) exhibits better electrical conduction capability, its voltage endurance capability is poor and cannot withstand the impact of high power. More specifically, the over-current protection device, also known as a resettable fuse, can return to a low electrical resistance state when cooled down after operation (i.e., tripping). That is, the over-current protection device is a fuse which can be reused several times (i.e., perform its protection function many times) without replacement. However, there is a limitation on the applied power during operation. If the applied power is too high, the over-current protection device is burnt out and cannot be reused anymore. In other words, the over-current protection device has its limit in terms of the power it can withstand (i.e., endurable power, also referred to as operable power) with a specific cycle number. It is understood that as miniaturization becomes a trend in over-current protection devices, the issue of the impact of high power could become more severe with decreasing device size.

Accordingly, there is still room for enhancement in terms of durability of the LR over-current protection device.

### SUMMARY OF THE INVENTION

The present invention provides an over-current protection device. More specifically, the over-current protection device has an electrode layer and a heat-sensitive layer, and the heat-sensitive layer includes a polymer matrix and a conductive filler. In order to enhance the durability of the heat-sensitive layer, the polymer matrix includes at least two fluoropolymers (referred to as “first fluoropolymer” and “second fluoropolymer” hereinafter) as its major constituent. The flowability of the second fluoropolymer is lower than that of the first fluoropolymer, and its melt flow index ranges from 0.4 g/10 min to 0.7 g/10 min, which is beneficial to provide structural support to the heat-sensitive layer and enhance its stability during the high-temperature operation. In addition, the present invention further adjusts the volume ratio of first fluoropolymer (with higher flowability) to second fluoropolymer (with lower flowability), and observes that the over-current protection device exhibits excellent durability. That is, the over-current protection device can withstand the impact of higher applied power for multiple times without burnout.

In accordance with an aspect of the present invention, an over-current protection device includes an electrode layer and a heat-sensitive layer. The electrode layer has a top metal layer and a bottom metal layer. The heat-sensitive layer contacts the top metal layer and the bottom metal layer, and is laminated therebetween. The heat-sensitive layer exhibits a positive temperature coefficient (PTC) characteristic and includes a polymer matrix and a conductive filler. The polymer matrix includes a first fluoropolymer and a second fluoropolymer. The first fluoropolymer has a first volume and a first melt flow index. The second fluoropolymer has a second volume and a second melt flow index. The second melt flow index ranges from 0.4 g/10 min to 0.7 g/10 min and is lower than the first melt flow index, and a volume ratio by dividing the second volume by the first volume ranges from 0.4 to 0.6. The conductive filler dispersed in the polymer matrix, thereby forming an electrically conductive path in the heat-sensitive layer.

In an embodiment, the total volume of the heat-sensitive layer is calculated as 100%, and the second fluoropolymer accounts for 12% to 16% by volume.

In an embodiment, the total volume of the heat-sensitive layer is calculated as 100%, and the polymer matrix accounts for 32% to 56% by volume.

In an embodiment, the total volume of the heat-sensitive layer is calculated as 100%, and the conductive filler accounts for 40% to 50% by volume.

In an embodiment, the conductive filler comprises carbon black and a metal carbide.

In an embodiment, the metal carbide is selected from the group consisting of tungsten carbide, titanium carbide, vanadium carbide, zirconium carbide, niobium carbide, tantalum carbide, molybdenum carbide, hafnium carbide, and any combination thereof.

In an embodiment, the over-current protection device has a top-view area ranging from 4 mm² to 12 mm².

In an embodiment, the top-view area of the over-current protection device ranges from 5 mm² to 10 mm², and the heat-sensitive layer has a thickness below 0.21 mm.

In an embodiment, the thickness of the heat-sensitive layer ranges from 0.11 mm to 0.21 mm.

In an embodiment, the first fluoropolymer is polyvinylidene difluoride, and the second fluoropolymer is represented by a structural formula (I):

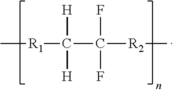

R₁ and R₂ are selected from the group consisting of CH₂, CF₂, CHF, C₂HF₃, C₂H₂F₂, C₂H₃F, C₂H₄, and C₂F₄. R₁ is different from R₂. n is at least 9000.

In an embodiment, an operable power of the over-current protection device is lower than 900 W.

In an embodiment, the operable power of the over-current protection device ranges from 600 W to 900 W. The over-current protection device is able to withstand an applied power ranging from 600 W to 800 W for 6000cycles without burnout. The over-current protection device is able to withstand an applied power of 900 W for 500 cycles without burnout.

In an embodiment, the over-current protection device has an electrical resistance ranging from 0.05 Ω to 0.2 Ω when cooled back to room temperature after being applied at 600 W for 500 cycles.

In an embodiment, the over-current protection device has an electrical resistance ranging from 0.09 Ω to 0.7 Ω when cooled back to room temperature after being applied at 800 W for 500 cycles.

In an embodiment, the over-current protection device has a low-temperature thermal derating ratio of trip current ranging from 0.5 to 0.6. The low-temperature thermal derating ratio of trip current is defined as a ratio of a required trip current of the over-current protection device under 85° C. divided by a required trip current of the over-current protection device under 23° C.

In an embodiment, the over-current protection device has a high-temperature thermal derating ratio of trip current ranging from 0.2 to 0.3. The high-temperature thermal derating ratio of trip current is defined as a ratio of a required trip current of the over-current protection device under 125° C. divided by a required trip current of the over-current protection device under 23° C.

In an embodiment, a trip power of the over-current protection device ranges from 60 W to 93 W at 23° C.

In an embodiment, a trip power per unit area of the over-current protection device ranges from 9 W/mm² to 12 W/mm² at 23°° C.

### BRIEF DESCRIPTION OF THE DRAWINGS

The present application will be described according to the appended drawings in which:

FIG. 1 shows a cross-sectional view of an over-current protection device in accordance with an embodiment of the present invention; and

FIG. 2 shows the top view of the over-current protection device shown in FIG. 1.

### DETAILED DESCRIPTION OF THE INVENTION

The making and using of the presently preferred illustrative embodiments are discussed in detail below. It should be appreciated, however, that the present application provides many applicable inventive concepts that can be embodied in a wide variety of specific contexts. The specific illustrative embodiments discussed are merely illustrative of specific ways to make and use the invention, and do not limit the scope of the invention.

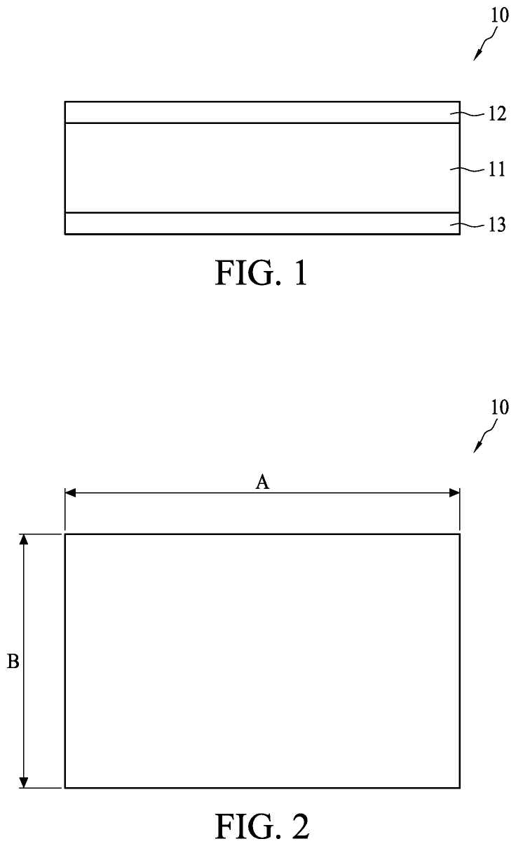

Please refer to FIG. 1. FIG. 1 shows one basic aspect of an over- current protection device 10 of the present invention in cross-sectional view. The over-current protection device 10 includes a heat-sensitive layer 11 and an electrode layer. The heat-sensitive layer 11 has a top surface and a bottom surface, and the electrode layer has a top metal layer 12 and a bottom metal layer 13 attached to the top surface and the bottom surface, respectively. Therefore, the heat-sensitive layer 11 physically contacts the top metal layer 12 and the bottom metal layer 13, and is laminated therebetween. In an embodiment, the top metal layer 12 and the bottom metal layer 13 may be composed of the nickel-plated copper foils or other conductive metals. In addition, the heat-sensitive layer 11 includes a polymer matrix and a conductive filler. The polymer matrix is an electrical insulator sensitive to heat, and the conductive filler is a conductor, by which the heat-sensitive layer 11 exhibits PTC characteristic. The over-current protection device 10 does not operate under normal condition, and therefore the conductive filler is uniformly dispersed in the polymer matrix, and particles of the conductive filler connect to each other in series, thereby forming an electrically conductive path; however, the polymer matrix rapidly expands when the over-current protection device 10 is subject to high temperature, and the particles of the conductive filler are pulled away from each other, thereby cutting off the electrically conductive path in the heat-sensitive layer 11.

In the present invention, the polymer matrix includes two fluoropolymers with different flowabilities (referred to as “first fluoropolymer” and “second fluoropolymer” hereinafter) as its major constituent. The first fluoropolymer may be a conventionally used polyvinylidene difluoride, which has higher flowability under high temperature and has a melt flow index ranging from 0.8 g/10 min to 1.4 g/10 min, such as 0.8 g/10 min, 0.9 g/10 min, 1 g/10 min, 1.1 g/10 min, 1.2 g/10 min, 1.3 g/10 min, or 1.4 g/10 min. The second fluoropolymer is a fluoropolymer having a chemical structural formula with skeleton similar to or the same as the first fluoropolymer, and has lower flowability under high temperature. The second fluoropolymer has a melt flow index ranging from 0.4 g/10 min to 0.7 g/10 min, such as 0.4 g/10 min, 0.45 g/10 min, 0.5 g/10 min, 0.55 g/10 min, or 0.6 g/10 min. In order to optimize the durability of the over-current protection device 10, a volume ratio of first fluoropolymer to second fluoropolymer is controlled within a specific range.

More specifically, the conventional over-current protection device includes a single type of fluoropolymer (e.g., single type of PVDF) as the polymer matrix for overheating protection at high temperature; if two fluoropolymers having the same monomer unit but different physical/chemical properties (e.g., two different types of PVDF) are used, it often does not result in a significant improvement or leads to a poor performance in electrical characteristics. In the latter case, it is due to complexity in formulation design. With the addition of each new compound, compatibility between such additional compound and the conventional polymer matrix, conductive filler and other inner fillers must be taken into consideration. Even though the additional compound is compatible with the conventional polymer matrix, conductive filler and other inner fillers, the proportion between them needs to be adjusted properly in order to maintain excellent electric characteristics, or otherwise the aforementioned issue of insignificant improvement or poor performance arises. However, through the appropriate adjustment of material proportions and physical properties according to the present invention, it is found that the combination of two fluoropolymers surpasses a single fluoropolymer in composing the polymer matrix. More specifically, the introduction of an additional fluoropolymer that is less prone to flow (i.e., the second fluoropolymer) into the polymer matrix can effectively stabilize the material structure. The present invention further finds that if the amount of the second fluoropolymer is lower than that of the first fluoropolymer and the ratio between them is set to a fixed value, the over-current protection device 10 can withstand the impact of higher applied power for multiple times without burnout. That is, the first fluoropolymer has a first volume and a first melt flow index, and the second fluoropolymer has a second volume and a second melt flow index. The second melt flow index ranges from 0.4 g/10 min to 0.7 g/10 min and is lower than the first melt flow index, and a volume ratio by dividing the second volume by the first volume ranges from 0.4 to 0.6, such as 0.4, 0.45, 0.5, 0.55, or 0.6. In a preferred embodiment, the volume ratio ranges from 0.45 to 0.55. According to the best embodiment, the volume ratio is 0.5. It is noted that the second melt flow index should be carefully controlled within a specific range. If the second melt flow index is lower than 0.4 g/10 min, it becomes challenging to manage the proportion of the second fluoropolymer. Specifically, if the flowability of the second fluoropolymer is too low, even a slight variation in its proportion will overly affect the overall flowability of the matrix as well as its electrical characteristics (especially the high power durability). If the second melt flow index is higher than 0.7 g/10 min, the second fluoropolymer would become so flowable that its flowability cannot significantly differ from that of the first fluoropolymer; and, thus even with an increased proportion, it would not substantially enhance the overall flowability of the polymer matrix.

Regarding specific volume content, the total volume of the heat-sensitive layer 11 is calculated as 100%, and the second fluoropolymer accounts for 12% to 16% by volume, such as 12%, 12.5%, 13%, 13.5%, 14%, 14.5%, 15%, 15.5%, or 16%. For example, if the volume ratio is 0.4,the first fluoropolymer may correspondingly account for 30% to 40% by volume; if the volume ratio is 0.5, the first fluoropolymer may correspondingly account for 24% to 32% by volume; and if the volume ratio is 0.6, the first fluoropolymer may correspondingly account for 20% to 27% by volume. In a preferred embodiment, the second fluoropolymer accounts for 13% to 15% by volume. According to the best embodiment, the second fluoropolymer accounts for 14% by volume. In addition to the utilization of different flowabilities between two fluoropolymers, the present invention further restricts the volume ratio to a small range of 0.4 to 0.6, thereby significantly improving the durability of the over-current protection device 10.

In addition, the present invention finds that the second fluoropolymer can generate a similar or identical technical effect as long as it contains a core structure similar to that of the first fluoropolymer. More specifically, if the first fluoropolymer is polyvinylidene difluoride, the second fluoropolymer is represented by a structural formula (I):

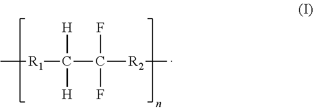

In the structural formula (I), a repeating unit is —CH₂CF₂— connected to two functional groups (i.e., R₁ and R₂), and is the core structure of the second fluoropolymer. R₁ and R₂ are selected from the group consisting of CH₂, CF₂, CHF, C₂HF₃C₂H₂F₂, C₂H₃F, C₂H₄, and C₂F₄. R₁ is different from R₂. For example, if R₁ is CH₂, R₂ is selected from the group consisting of CF₂, CHF, C₂HF₃, C₂H₂F₂, C₂H₃F, C₂H₄, and C₂F₄. “n” is the repeating number of the repeating unit, and is at least 9000. In an embodiment, the second fluoropolymer may also be polyvinylidene difluoride, that is, R₁ is CF₂ and R₂ is CH₂.

Moreover, the polymer matrix of the present invention may further include a third fluoropolymer. The third fluoropolymer is selected from the group consisting of polytetrafluoroethylene, ethylene-tetrafluoroethylene copolymer, tetrafluoroethylene-hexafluoro-propylene copolymer, perfluoroalkoxy modified tetrafluoroethylenes, poly (chlorotri-fluorotetrafluoroethylene), vinylidene fluoride-tetrafluoroethylene copolymer, tetrafluoroethylene-perfluorodioxole copolymer, vinylidene fluoride-hexafluoropropylene copolymer, vinylidene fluoride-hexafluoropropylene-tetrafluoroethylene terpolymer, and any combination thereof. The melting point of the third fluoropolymer is much higher than that of the first fluoropolymer and the second fluoropolymer. For example, the melting points of the first fluoropolymer and the second fluoropolymer range from 170°° C. to 186° C., and the melting point of the third fluoropolymer ranges from 320° C. to 335° C. If the environmental temperature is higher than the melting points of the first fluoropolymer and the second fluoropolymer but lower than the melting point of the third fluoropolymer, both the first fluoropolymer and the second fluoropolymer melt but the third fluoropolymer does not. In this manner, particles of the third fluoropolymer remain in the solid state and are uniformly dispersed within the heat-sensitive layer 11, thereby establishing nucleation sites for and favorable to the recrystallization of the first and second fluoropolymers. Additionally, the third fluoropolymer experiences less severe deformation because of its higher melting temperature when subject to high temperature. As a result, the structure of the heat-sensitive layer 11 is stabilized by the third fluoropolymer, preventing severe deformation.

As for the conductive filler, it includes at least one metal compound besides carbon black so that the electrical conduction of the over-current protection device 10 can be enhanced. The metal compound is selected from the group consisting of tungsten carbide, titanium carbide, vanadium carbide, zirconium carbide, niobium carbide, tantalum carbide, molybdenum carbide, hafnium carbide, titanium boride, vanadium boride, zirconium boride, niobium boride, molybdenum boride, hafnium boride, zirconium nitride, and any combination thereof. In consideration of material compatibility, a metal carbide is preferably selected as the metal compound in the present invention. In a preferred embodiment, the metal carbide is selected from the group consisting of tungsten carbide, titanium carbide, vanadium carbide, zirconium carbide, niobium carbide, tantalum carbide, molybdenum carbide, hafnium carbide, and any combination thereof. The total volume of the heat-sensitive layer 11 is calculated as 100%, and the conductive filler accounts for 40% to 50% by volume.

Besides the aforementioned polymer matrix and conductive filler, the heat-sensitive layer 11 further includes an inner filler. The inner filler is selected from the group consisting of barium titanate (BaTiO₃), strontium titanate (SrTiO₃), calcium titanate (CaTiO₃), and any combination thereof. More specifically, the present invention does not include any conventional flame retardant (e.g., boron nitride, aluminum nitride, aluminium oxide, or magnesium hydroxide), but uses a compound with perovskite structure (i.e., the above BaTiO₃, SrTiO₃, and CaTiO₃). The compound with perovskite structure exhibits a better dielectric property, and offers a flame retardant effect better than the conventional one when combined with the first fluoropolymer and the second fluoropolymer, thereby further enhancing the voltage endurance capability of the over-current protection device 10.

Besides the improvement of the material composition, the over-current protection device 10 of the present invention may have different sizes. Please refer to FIG. 2, which shows the top view of the over-current protection device 10 shown in FIG. 1. The over-current protection device 10 has a length A and a width B, and the top-view area “A×B” of the over-current protection device 10 is substantially equivalent to the top-view area of the heat-sensitive layer 11. The heat-sensitive layer 11 may have a top-view area ranging from 4 mm² to 72 mm² based on different products having different sizes. For example, the top-view area “A×B” may be 2×2 mm², 2.3×2.3 mm², 2.5×3 mm², 2.8×3.5 mm², 4×4 mm², 5×5 mm², 5.1×6.1 mm², 5×7 mm², 7.62×7.62 mm², 8.2×7.15 mm², 7.3×9.5 mm², or 7.62×9.35 mm². In addition, the total thickness of the over-current protection device 10 (i.e., the total thickness of the top metal layer 12, the heat-sensitive layer 11, and the bottom metal layer 13) ranges from 0.25 mm to 0.35 mm. More specifically, the thickness of each of the upper metal layer 12 and the lower metal layer 13 is 0.07 mm, and the thickness of the heat-sensitive layer 11 correspondingly ranges from 0.11 mm, 0.12 mm, 0.13 mm, 0.14 mm, 0.15 mm, 0.16 mm, 0.17 mm, 0.18 mm, 0.19 mm, 0.2 mm, 0.21 mm. Because of the enhancement in durability, the over-current protection device 10 can be manufactured in a smaller size while exhibiting excellent reproducibility in high-power endurance. In a preferred embodiment, the top-view area of the over-current protection device 10 ranges from 4 mm² to 12 mm², and the thickness of the heat-sensitive layer 11 can be made thinner (about 0.15 mm to 0.17 mm). In the best embodiment, the top-view area of the over-current protection device 10 ranges from 5 mm² to 10 mm², and the thickness of the heat-sensitive layer 11 is 0.16 mm. According to the dimensions of the best embodiment mentioned above, the over-current protection device 10 exhibits optimal stability during the tests for electrical characteristics. It is understood that the present invention can apply to any size of the over-current protection device 10 described above to achieve the same technical effect. The over-current protection device 10 can be processed into different device types commonly used in the industry, such as surface-mount device (SMD), axial-leaded device (ALD), radial-leaded device (RLD), or other device types, depending on the requirements.

Based on the above composition and dimensions, the over-current protection device 10 of the present invention includes several electrical characteristics. These electrical characteristics are described in the following tests: cycle life test and thermal derating effect test.

In the cycle life test, the operable power of the over-current protection device 10 may range from 600 W to 900 W. The term “operable power” mentioned above refers to an applied power that the over-current protection device 10 can withstand for a specific number of cycles without burnout. One cycle of the cycle life test includes applying a specific power for 10seconds and then turning it off for 60 seconds (i.e., on: 10 seconds; off: 60 seconds). For example, the over-current protection device 10 is able to withstand an applied power ranging from 600 W to 800 W for 6000 cycles without burnout. In another embodiment, the over-current protection device 10 is able to withstand an applied power of 900 W for 500 cycles without burnout. From the above, the durability of the over-current protection device 10 is enhanced after the improvement. At a fixed cycle number, the over-current protection device 10 can withstand a higher applied power without burnout. Similarly, at a fixed applied power, the over-current protection device 10 can endure more cycles without burnout. In either case, the ability of over-current protection device 10 to withstand the energy impact is significantly enhanced, thus improving its durability.

Moreover, the over-current protection device 10 not only can withstand higher applied power for cycles, but also can return to a low electrical resistance state. For example, after being applied at 600 W for 500 cycles, the over-current protection device 10 has an electrical resistance ranging from 0.05 Ω to 0.2 Ω when it is cooled back to room temperature. In an embodiment, the electrical resistance mentioned above ranges from 0.05 Ω to 0.18 Ω. In a preferred embodiment, the electrical resistance mentioned above ranges from 0.05 Ω to 0.11 Ω. If the applied power increases, the over-current protection device 10 is not burnt out and may return to the state of low electrical resistance. After being applied at 800 W for 500 cycles, the over-current protection device 10 has an electrical resistance ranging from 0.09 Ω to 0.7 Ω when it is cooled back to room temperature. In an embodiment, the electrical resistance mentioned above ranges from 0.09 Ω to 0.66 Ω. In a preferred embodiment, the electrical resistance mentioned above ranges from 0.09 Ω to 0.13 Ω.

In the thermal derating effect test, the over-current protection device 10 exhibits two different trip-current thermal derating ratios, indicating distinct thermal derating features under relatively low (85° C.) and relatively high (125° C.) temperatures, respectively. First, the over-current protection device 10 has a low-temperature thermal derating ratio of trip current ranging from 0.5 to 0.6. The low-temperature thermal derating ratio of trip current is defined as a ratio of a required trip current of the over-current protection device under 85° C. divided by a required trip current of the over-current protection device under 23° C. Second, the over-current protection device 10 has a high-temperature thermal derating ratio of trip current ranging from 0.2 to 0.3. The high-temperature thermal derating ratio of trip current is defined as a ratio of a required trip current of the over-current protection device under 125° C. divided by a required trip current of the over-current protection device under 23° C. The thermal derating effect test is used to compare the difference between the required trip currents of the over-current protection device 10 at different environmental temperatures, and it can be used to assess the impact of high temperature on operational performance. Ideally, the user would expect the same (or similar) value of the required trip currents of the over-current protection device 10 under different environmental temperatures so that the over-current protection device 10 can perform its function of over-current protection at a stable preset current (i.e., the preset required trip current), offering operational convenience. The over-current protection device 10 of the present invention can withstand high voltage and high power without exhibiting significant issues in thermal derating, demonstrating excellent operational convenience.

As described above, the present invention allows the over-current protection device 10 to exhibit excellent electrical characteristics under high temperature. It can be verified according to the experimental data in Table 1 to Table 6 as shown below.

TABLE 1
Major polymers of the polymer matrix.

| Polymer | Melt flow index (g/10 min) |
|---|---|
| PVDF-1 | 1.1 |
| PVDF-2 | 0.55 |
| PVDF-3 | 6 |

TABLE 2
Volume percentage (vol %) of the heat-sensitive layer.

| Group | PVDF-1 | PVDF-2 | PVDF-3 | PTFE | BaTiO₃ | Mg(OH)₂ | CB | WC |
|---|---|---|---|---|---|---|---|---|
| E1 | 28 | 14 | 0 | 4 | 10 | 0 | 4 | 40 |
| E2 | 28 | 14 | 0 | 4 | 10 | 0 | 4 | 40 |
| E3 | 28 | 14 | 0 | 4 | 10 | 0 | 4 | 40 |
| C1 | 43 | 0 | 0 | 5 | 10 | 0 | 0 | 42 |
| C2 | 0 | 0 | 45 | 5 | 0 | 5 | 0 | 45 |

TABLE 3
Size of over-current protection device and proportion of PVDF-2

| | | | | | PVDF-2/ |
|---|---|---|---|---|---|
| | Top-view | Thickness | Form | PVDF-2/ | (PVDF-1 + |
| Group | area (mm²) | (mm) | factor | PVDF-1 | PVDF-2) |
| E1 | 9.8 | 0.3 | 1210-1812 | 0.500 | 0.33 |
| E2 | 7.5 | 0.3 | ~1210 | 0.500 | 0.33 |
| E3 | 5.29 | 0.3 | ~1206 | 0.500 | 0.33 |
| C1 | 7.5 | 0.3 | ~1210 | 0 | 0 |
| C2 | 7.5 | 0.35 | ~1210 | 0 | 0 |

Table 1 shows the major polymers in the polymer matrix, that is, three types of polyvinylidene difluoride (PVDF) referred to as first polyvinylidene difluoride (PVDF-1), second polyvinylidene difluoride (PVDF-2), and third polyvinylidene difluoride (PVDF-3) hereinafter. In accordance with the standard of ASTM D1238, PVDF-2 exhibits the lowest melt flow index at 0.55 g/10 min, while PVDF-1 and PVDF-3 exhibit the higher ones at 1.1 g/10 min and 6 g/10 min, respectively.

Please refer to Table 2. Table 2 shows the volume percentage composition of the heat-sensitive layer in accordance with the embodiments (E1 to E3) of the present disclosure and the comparative examples (C1 and C2). The first column in Table 1 shows test groups E1-C2 from top to bottom. The first row in Table 1 shows various materials used for the heat-sensitive layer from left to right, that is, polyvinylidene fluoride (PVDF-1,PVDF-2, and PVDF-3), polytetrafluoroethylene (PTFE), barium titanate (BaTiO₃), magnesium hydroxide (Mg (OH)₂), carbon black (CB), and tungsten carbide (WC). The test groups E1 to C1 adopt barium titanate as a substitute for the conventional flame retardant used in over-current protection devices, and the test group C2 uses the conventional flame retardant (i.e., magnesium hydroxide) commonly selected for over-current protection devices. In order to enhance electrical conduction, tungsten carbide is the major constituent and carbon black is the minor constituent of the conductive filler. The combination of tungsten carbide and carbon black in such proportion may also be referred to as a type of LR (low resistivity) system's conductive fillers.

In the embodiments E1 to E3 of the present invention, the major constituent of the polymer matrix consists of two types of PVDF (i.e., PVDF-1 and PVDF-2), and the minor constituent of the polymer matrix is PTFE. Since PTFE has a much higher melting point (about 330° C.) than that of PVDF, the proportion of PTFE must not be too high to avoid affecting the processability and other unexpectedly adverse issues to the trip event of the over-current protection device. The proportion of PVDF relative to PTFE needs to be carefully controlled. It is noted that the major constituent of the polymer matrix has two types of PVDF with two different physical/chemical properties, rather than a single type of PVDF, which adds greater complexity to the formulation design. Based on the types of the flame retardant and conductive filler, the optimal ratio of PVDF to PTFE of the present invention is approximately 10:1 to 11:1. Therefore, the combined volume percentage of PVDF-1 and PVDF-2 is about 42%, and the volume percentage of PTFE is 4%. Notably, the present invention further finds that the over-current protection device achieves optimal durability when the ratio of PVDF-1:PVDF-2 is 2:1, and hence, either the proportion of PVDF-1 or PVDF-2 in the embodiments E1 to E3 is fixed. As for the comparative examples C1 and C2, the major constituent of the polymer matrix consists of a single type of PVDF, and the minor constituent of the polymer matrix is PTFE. Conventionally, a single type of PVDF is often used as the major constituent of the polymer matrix, based on the types of the flame retardant and conductive filler. However, both PVDF-1and PVDF-3 result in poor electrical characteristics. Subsequent tests will demonstrate that the embodiments E1 to E3 of the present invention have better performance than the comparative examples C1 and C2.

Please refer to Table 3. To verify that the over-current protection device of the present invention can have the same technical effect when its size is scaled up or down, the top-view area in the embodiments E1 to E3 of the present invention varies. More specifically, in the embodiment E2, comparative example C1, and comparative example C2, the over-current protection devices all have the same top-view area (i.e., 7.5 mm²) and correspond to the same form factor (i.e., 1210); in the embodiment E1, the size of the over-current protection device is scaled up, and its top-view area is 9.8 mm², corresponding to a form factor between 1210 and 1812; and in the embodiment E3, the size of the over-current protection device is scaled down, and its top-view area is 5.29 mm², corresponding to a form factor of 1206. It should be noted that, in the industry, the length of the over-current protection device with the form factor 1210 is about 3 mm to 3.43 mm, and the width of it is about 2.35 mm to 2.8 mm; the length of the over-current protection device with the form factor 1812 is about 4.37 mm to 4.73 mm, and the width of it is about 3.07 mm to 3.41 mm; and the length of the over-current protection device with the form factor 1206 is about 3 mm to 3.4mm, and the width of it is about 1.5 mm to 1.8 mm. Regarding the thickness, the top and bottom metal layers of the over-current protection devices in all test groups are made of copper foil, and each copper foil has a thickness of 2 oz (i.e., 0.07 mm). As a result, in the embodiments E1 to E3 and the comparative example C1, the heat-sensitive layer has a thickness of 0.16 mm; and in the comparative example C2, the heat-sensitive layer has a thickness of 0.21 mm. Once again, it is noted that the ratio of PVDF-1 to PVDF-2 is fixed to pursue the optimal durability, and thus the specific proportions between PVDF-1 and PVDF-2 are listed in Table 3 for clarification. “PVDF-2/PVDF-1” refers to a volume ratio of PVDF-2 to PVDF-1. Considering the measurement error and the permissible error tolerance, the ratio above (PVDF-2/PVDF-1) may vary within the range of 0.4 to 0.6 while still achieving the same technical effect, such as 0.4, 0.45,0.5, 0.55, or 0.6. “PVDF-2/(PVDF-1+PVDF-2)” refers a proportion of PVDF-2 in the major constituent of the polymer matrix, specifically, the volume of PVDF-2 divided by the combined volume of PVDF-1 and PVDF-2. Considering the measurement error and the permissible error tolerance, the ratio above (PVDF-2/(PVDF-1+PVDF-2)) may vary within the range of 0.3 to 0.4 while still achieving the same technical effect, such as 0.3, 0.35, or 0.4.

The manufacturing process of the embodiments E1 to E3 and the comparative examples C1 to C2 is described below. According to the composition shown in Table 2, materials are prepared and put into HAAKE twin screw blender for blending. The blending temperature is 215° C., the time for pre-mixing is 3 minutes, and the blending time is 15 minutes. The conductive polymer after being blended is pressed into a sheet by a hot press machine at a temperature of 210° C. and a pressure of 150 kg/cm². The sheet is then cut into pieces of about 20 cm×20 cm, and two nickel-plated copper foils are laminated to two sides of the sheet with the hot press machine at a temperature of 210° C. and a pressure of 150 kg/cm², by which a three-layered structure is formed. Then, the sheet with the nickel-plated copper foils is punched into PTC chips, each of which is the over-current protection device. Then, the PTC chips of the embodiments and comparative examples are subjected to electron beam irradiation of 200 kGy (irradiation dose can be adjusted depending on the requirement). After irradiation, the following measurements are performed by taking fifteen PTC chips as samples to be tested for each of the groups.

TABLE 4
Cycle life test.

| | R_{500 C}@12 | R_{500 C}@16 | | | |
|---|---|---|---|---|---|
| | V/50 A | V/50 A | 600 W_{—} | 800 W_{—} | 900 W_{—} |
| Group | (Ω) | (Ω) | 6000 C | 6000 C | 500 C |
| E1 | 0.05850 | 0.0919 | Pass | Pass | Pass |
| E2 | 0.10180 | 0.1207 | Pass | Pass | Pass |
| E3 | 0.17980 | 0.6632 | Pass | Pass | Fail |
| C1 | — | — | Fail | Fail | Fail |
| C2 | — | — | Fail | Fail | Fail |

As shown in Table 4, the first row shows items to be tested from left to right.

“R_{500c}@12V/50A” refers to the electrical resistance of the over-current protection device when it is cooled back to room temperature after 500 cycles of the cycle life test. One cycle of this test involves applying 12V/50A for 10 seconds and then turning it off for 60 seconds, and 500 cycles above are performed.

“R_{500c}@16V/50A” refers to the electrical resistance of the over-current protection device when it is cooled back to room temperature after 500 cycles of the cycle life test. One cycle of this test involves applying 16V/50A for 10 seconds and then turning it off for 60 seconds, and 500 cycles above are performed.

In order to assess the durability of the over-current protection device, three different cycle life tests are further conducted. “600W_6000C” refers to the test condition with the applied power at 600 W (12V/50A) and the cycle number of 6000. “800W_6000C” refers to the test condition with the applied power at 800 W (16V/50A) and the cycle number of 6000.“900W_500C” refers to the test condition with the applied power at 900 W (18V/50A) and the cycle number of 500.

In Table 4, all the embodiments E1 to E3 of the present invention can pass the cycle life test at 800 W for 6000 cycles without burnout, and the embodiments E1 and E2 can further pass the cycle life test at 900 W for 500 cycles without burnout. In the case with the applied power of 900 W, the embodiments E1 and E2 are still burnt out if the cycle number exceeds 500. Nevertheless, the composition of the present invention allows the over-current protection device to withstand such high power for 500 cycles, demonstrating its excellent performance in durability. In contrast, the comparative examples C1 to C2 are burnt out under any test condition mentioned above, and are even unable to withstand 500 cycles at 600W (12V/50A). Additionally, the embodiments E1 to E3 not only have excellent durability but also can return to the low electrical resistance state after the tests. R_{500c}@12V/50A ranges from 0.05 Ω to 0.18 Ω, and R_{500c}@16V/50A ranges from 0.09 Ω to 0.7 Ω. Comparative Examples C1 and C2 cannot pass any test condition described above, and as a result, there is no data for R_{500c}@12V/50A and R_{500c}@16V/50A.

TABLE 5
Thermal derating effect test

| | I-T_{23° C.} | I-T_{23° C.}/area | I-T_{85° C.} | I-T_{85° C.}/area | I-T_{125° C.} | I-T_{125° C.}/area | I-T_{85° C.}/ | I-T_{125° C.}/ |
|---|---|---|---|---|---|---|---|---|
| Group | (A) | (A/mm²) | (A) | (A/mm²) | (A) | (A/mm²) | I-T_{23° C.} | I-T_{23° C.} |
| E1 | 5.76 | 0.59 | 3.24 | 0.33 | 1.62 | 0.17 | 0.56 | 0.28 |
| E2 | 4.52 | 0.60 | 2.56 | 0.34 | 1.28 | 0.17 | 0.57 | 0.28 |
| E3 | 3.86 | 0.73 | 2.06 | 0.39 | 1.04 | 0.20 | 0.53 | 0.27 |
| C1 | 4.50 | 0.60 | 2.45 | 0.33 | 1.10 | 0.15 | 0.54 | 0.24 |
| C2 | 7.42 | 0.99 | 4.42 | 0.59 | 2.74 | 0.37 | 0.60 | 0.37 |

As shown in Table 5, the first row shows items to be tested from left to right.

“I-T_{23° C.}”, “I-T_{85° C.}”, and “I-T_{125° C.}” refer to trip currents of the over-current protection device at the environmental temperature of 23° C., 85° C., and 125° C., respectively. “I-T_{23° C.}/area”, “I-T_{85° C.}/area”, and “I-T125° C./area” refer to trip currents per unit area of the over-current protection device at the environmental temperature of 23° C., 85°° C., and 125° C., respectively. Additionally, it should be noted that in the embodiments E1 to E3, the trip voltage is about 16V, whereas in the comparative examples C1 and C2, the trip voltage is about 6V.

“I-T_{85° C.}/I-T_{23°C.}” is the low-temperature thermal derating ratio of trip current as previously defined, and “I-T_{125° C.}/I-T_{23°C.}” is the high-temperature thermal derating ratio of trip current as previously defined. The over-current protection device requires different trip currents at different temperatures. In the relatively low temperature environment, the over-current protection device has a lower electrical resistance, leading to a relatively higher required trip current. In the relatively high temperature environment, the over-current protection device has a higher electrical resistance, leading to a relatively lower required trip current. Therefore, the thermal derating ratio of trip current can be used to assess the impact of rising temperature on the operational convenience of the device.

In the embodiments E1 to E3, the low-temperature thermal derating ratio of trip current (I-T_{85° C.}/I-T_{23° C.}) varies within the range of 0.53 to 0.56, and the high-temperature thermal derating ratio of trip current (I-T_{125° C.}/I-T_{23° C.}) varies within the range of 0.27 to 0.28. In the comparative examples C1 to C2, the low-temperature thermal derating ratio of trip current (I-T_{85° C.}/ I-T_{23° C.}) and the high-temperature thermal derating ratio of trip current (I-T_{125° C.}/I-T_{23° C.}) are approximately within the range mentioned above. This indicates that after the improvement according to the embodiments E1 to E3, the durability of the over-current protection device can be greatly enhanced without compromising operational convenience. That is, the composition of the present invention does not sacrifice the performance of one electrical characteristic (operability) for the improvement of another electrical characteristic (durability).

TABLE 6
Other electrical characteristics

| | | | | | | Trip power per |
|---|---|---|---|---|---|---|
| | Rᵢ | ρᵢ | R₁ | ρ₁ | Trip power | unit area |
| Group | (Ω) | (Ω · cm) | (Ω) | (Ω · cm) | (W) | (W/mm²) |
| E1 | 0.0042 | 0.0137 | 0.0108 | 0.0353 | 92.12 | 9.400 |
| E2 | 0.0066 | 0.0164 | 0.0149 | 0.0372 | 72.32 | 9.643 |
| E3 | 0.0099 | 0.0175 | 0.0261 | 0.0461 | 61.76 | 11.675 |
| C1 | 0.0072 | 0.0180 | 0.0182 | 0.0454 | 27.00 | 3.600 |
| C2 | 0.0028 | 0.0060 | 0.0076 | 0.0164 | 44.52 | 5.936 |

Table 6 shows the rest data for verification.

“Rᵢ” refers to the initial electrical resistance of the over-current protection device at room temperature.

“R₁” refers to the electrical resistance of the PTC chip when it is cooled back to room temperature after one cycle of a reflow treatment. During the reflow treatment, the temperature ranges from 140° C. to 300° C. for a duration around 5 minutes. In addition, the electrical resistance formula is ρ=R×A/L, where “R” is electrical resistance, “L” is length (thickness), and “A” is cross sectional area. Accordingly, the electrical resistivity ρᵢ and ρ₁ can be calculated based on Rᵢ and R₁.

The trip voltage of the embodiments E1-E3 is about 16V and the trip voltage of the comparative examples C1-C2 is about 6V as described above, and hence “trip power” and “trip power per unit area” of the over-current protection device at 23° C. can be further calculated.

In the embodiments E1 to E3 of the present invention, the initial electrical resistance (Rᵢ) ranges from 0.0042 Ω to 0.0099 Ω, and R₁ ranges from 0.0108 Ω to 0.0261 Ω. Rᵢ and R₁ of the comparative examples C1 and C2 have the similar values to those mentioned above. However, when it comes to the endurable power (i.e., trip power) during the trip event, the over-current protection device 10 of the present invention can withstand it higher than the conventional one. More specifically, the trip power of the embodiments E1 to E3 varies within the range of 61.76 W to 92.12 W, which is much higher than the trip power of the comparative examples C1 and C2 (i.e., 27 W to 44.52 W). Similarly, the trip power per unit area of the embodiments E1 to E3 varies within the range of 9.4 W/mm² to 11.675 W/mm², which is much higher than the trip power per unit area of the comparative examples C1 and C2 (i.e., 3.6 W/mm² to 5.936 W/mm²). The over-current protection device 10 of the present invention can pass various kinds of high-power cycle life tests while withstanding a much higher power during the trip event.

The above-described embodiments of the present invention are intended to be illustrative only. Numerous alternative embodiments may be devised by persons skilled in the art without departing from the scope of the following claims.

What is claimed is:

1. An over-current protection device, comprising:
an electrode layer having a top metal layer and a bottom metal layer; and
a heat-sensitive layer contacting the top metal layer and the bottom metal layer, and being laminated therebetween, wherein the heat-sensitive layer exhibits a positive temperature coefficient (PTC) characteristic and comprises:
a polymer matrix comprising a first fluoropolymer and a second fluoropolymer, wherein:
the first fluoropolymer has a first volume and a first melt flow index;
the second fluoropolymer has a second volume and a second melt flow index, wherein the second melt flow index ranges from 0.4 g/10 min to 0.7 g/10 min and is lower than the first melt flow index, and a volume ratio by dividing the second volume by the first volume ranges from 0.4 to 0.6; and
a conductive filler dispersed in the polymer matrix, thereby forming an electrically conductive path in the heat-sensitive layer.

2. The over-current protection device of claim 1, wherein the total volume of the heat-sensitive layer is calculated as 100%, and the second fluoropolymer accounts for 12% to 16% by volume.

3. The over-current protection device of claim 1, wherein the total volume of the heat-sensitive layer is calculated as 100%, and the polymer matrix accounts for 32% to 56% by volume.

4. The over-current protection device of claim 1, wherein the total volume of the heat-sensitive layer is calculated as 100%, and the conductive filler accounts for 40% to 50% by volume.

5. The over-current protection device of claim 1, wherein the conductive filler comprises carbon black and a metal carbide.

6. The over-current protection device of claim 5, wherein the metal carbide is selected from the group consisting of tungsten carbide, titanium carbide, vanadium carbide, zirconium carbide, niobium carbide, tantalum carbide, molybdenum carbide, hafnium carbide, and any combination thereof.

7. The over-current protection device of claim 1, wherein the over-current protection device has a top-view area ranging from 4 mm² to 12 mm².

8. The over-current protection device of claim 7, wherein the top-view area of the over-current protection device ranges from 5 mm² to 10 mm², and the heat-sensitive layer has a thickness below 0.21 mm.

9. The over-current protection device of claim 8, wherein the thickness of the heat-sensitive layer ranges from 0.11 mm to 0.21 mm.

10. The over-current protection device of claim 1, wherein the first fluoropolymer is polyvinylidene difluoride, and the second fluoropolymer is represented by a structural formula (I): 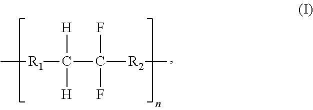
wherein:
R₁ and R₂ are selected from the group consisting of CH₂, CF₂, CHF, C₂HF₃, C₂H₂F₂, C₂H₃F, C₂H₄, and C2F4;
R₁ is different from R₂; and
n is at least 9000.

11. The over-current protection device of claim 1, wherein an operable power of the over-current protection device is lower than 900 W.

12. The over-current protection device of claim 11, wherein the operable power of the over-current protection device ranges from 600 W to 900 W, and wherein:
the over-current protection device is able to withstand an applied power ranging from 600 W to 800 W for 6000 cycles without burnout; and
the over-current protection device is able to withstand an applied power of 900 W for 500 cycles without burnout.

13. The over-current protection device of claim 12, wherein the over-current protection device has an electrical resistance ranging from 0.05 Ω to 0.2 Ω when cooled back to room temperature after being applied at 600 W for 500 cycles.

14. The over-current protection device of claim 13, wherein the over-current protection device has an electrical resistance ranging from 0.09 Ω to 0.7 Ω when cooled back to room temperature after being applied at 800 W for 500 cycles.

15. The over-current protection device of claim 1, wherein the over-current protection device has a low-temperature thermal derating ratio of trip current ranging from 0.5 to 0.6, wherein the low-temperature thermal derating ratio of trip current is defined as a ratio of a required trip current of the over-current protection device under 85° C. divided by a required trip current of the over-current protection device under 23° C.

16. The over-current protection device of claim 1, wherein the over-current protection device has a high-temperature thermal derating ratio of trip current ranging from 0.2 to 0.3, wherein the high-temperature thermal derating ratio of trip current is defined as a ratio of a required trip current of the over-current protection device under 125° C. divided by a required trip current of the over-current protection device under 23° C.

17. The over-current protection device of claim 1, wherein a trip power of the over-current protection device ranges from 60 W to 93 W at 23° C.

18. The over-current protection device of claim 17, wherein a trip power per unit area of the over-current protection device ranges from 9 W/mm² to 12 W/mm² at 23° C.
